(19) United States
(12) Patent Application Publication
(10) Pub. No.: US 2025/0105389 A1
(43) Pub. Date: Mar. 27, 2025

(54) COOLING APPARATUS OF BATTERY SYSTEM

(71) Applicants: Hyundai Motor Company, Seoul (KR); Kia Corporation, Seoul (KR)

(72) Inventors: Gyung Hoon Shin, Seoul (KR); Eung Gyu Lee, Hwaseong-si (KR); Yong Hwan Choi, Seoul (KR); Hae Woong Jung, Anyang-si (KR)

(21) Appl. No.: 18/412,831

(22) Filed: Jan. 15, 2024

(30) Foreign Application Priority Data
Sep. 25, 2023 (KR) 10-2023-0128473

(51) Int. Cl. H01M 10/613; H01M 10/625; H01M 10/6556

(52) U.S. Cl. CPC H01M 10/613; H01M 10/625; H01M 10/6556

(57) ABSTRACT

An embodiment battery system cooling apparatus includes a lower case, a plurality of battery modules mounted in multiple stages on an outer surface of the lower case, a plurality of cooling blocks respectively attached to outer surfaces of the battery modules and defining a cooling passage, an upper case coupled to the lower case and covering the battery modules and the cooling blocks, and a cooling hose respectively connected in parallel to the cooling blocks on an outside of the upper case, the cooling hose including an inlet and an outlet for circulation of a cooling medium.

### CROSS-REFERENCE TO RELATED APPLICATIONS

This application claims the benefit of Korean Patent Application No. 10-2023-0128473, filed on Sep. 25, 2023, which application is hereby incorporated herein by reference.

### TECHNICAL FIELD

The present disclosure relates to a cooling apparatus of a battery system.

### BACKGROUND

Electrified vehicles that use electric motors to drive the vehicle, such as hybrid vehicles, fuel cell vehicles, and electric vehicles, are equipped with a high-voltage battery unit that stores driving power provided to the electric motors.

Typically, a high-voltage battery unit may include a case forming a sealed internal space for the battery, a battery module that contains a plurality of battery cells and is installed in the sealed internal space inside the case, and a battery management system (BMS) that monitors the voltage, current, and temperature of the battery cell inside the battery module and performs control for battery management according thereto.

Here, a cooling structure is applied to the battery module to maintain an appropriate temperature, and various cooling methods such as air cooling and water cooling are adopted.

In particular, as the recent battery system is based on a dedicated platform, the battery system is installed at the bottom of the vehicle.

However, in the case of a high-performance electric vehicle to secure a high-performance driver's seat, there are limitations in securing the overall height of the vehicle, which restricts installation of a battery system to the bottom of the vehicle.

Accordingly, a structure is required to enable installation of the battery system to a portion other than the bottom of the vehicle and effective cooling of the battery system.

To this end, although battery modules may be mounted in multiple stages, this results in a complicated cooling structure and a reduction in assembly convenience, so there is a limitation in completely blocking leakage of the cooling medium due to assembly errors.

The foregoing described as the background is intended merely to aid in the understanding of the background of embodiments of the present disclosure and is not intended to mean that the embodiments of the present disclosure fall within the purview of the related art already known to those skilled in the art.

### SUMMARY

The present disclosure relates to a cooling apparatus of a battery system. Particular embodiments relate to a battery system cooling apparatus that diversifies the installation location of a battery system by mounting battery modules and cooling blocks in multiple stages, prevents leakage of a cooling medium, and reduces vibration of the battery to ensure stability.

Embodiments of the present disclosure can solve problems in the prior art, and an embodiment of the present disclosure provides a battery system cooling apparatus in which battery modules and cooling blocks are mounted in multiple stages, thereby diversifying the installation locations of the battery system, preventing leakage of a cooling medium, and reducing vibration of the battery to ensure stability.

A battery system cooling apparatus according to an embodiment of the present disclosure may include a lower case, a plurality of battery modules mounted in multiple stages on an outer surface of the lower case, a plurality of cooling blocks attached to the outer surfaces of the respective battery modules and forming a cooling passage, an upper case coupled to the lower case and formed to cover the battery modules and the cooling blocks, and a cooling hose including an inlet and an outlet for circulation of a cooling medium and connected in parallel to the respective cooling blocks on the outside of the upper case.

Electrical equipment may be provided on an upper side of the uppermost battery module among the plurality of battery modules, and the cooling block may be attached to an outer surface of the electrical equipment.

The cooling hose may be connected such that the cooling medium initially flows through the cooling blocks matched to the respective battery modules and lastly flows to the cooling block matched to the electrical equipment.

The lower case and the upper case may be configured as a front part and a rear part so that the front part and the rear part may be connected at right angles to form a T shape.

Each cooling block may have both ends sealed by sealing portions so that the cooling passage may be formed inside the same.

Each cooling block may have a connection port to which the cooling hose is connected, and the connection port may extend upwards from the cooling block to be connected to the cooling hose by passing through the upper case.

The lowermost cooling block of the plurality of cooling blocks may be formed to have the largest length in the longitudinal direction, and the cooling block may have a smaller length in the longitudinal direction as it is closer to the top.

As first ends of the plurality of cooling blocks are positioned to match each other in the vertical direction, the second ends thereof may be arranged in the form of stairs, and the connection ports may be provided at the ends arranged in the stair form.

The lower end of the connection port may be connected to the cooling passage of the cooling block so as to communicate therewith, a locking protrusion may be formed at the upper end thereof, and a first fastening member may be seated on the locking protrusion so as to be interposed between the outer surface of the upper case and the locking protrusion.

A second fastening member may be further provided in a portion on the upper surface of the upper case through which the connection port passes so as to be connected to the connection port.

The cooling hose may be connected to the connection port via a connector, the connector and the connection port may have a fastening protrusion or groove formed therein to provide a mutual locking structure, and a sealing body may be interposed between the connector and the connection port.

The cooling hose may extend along the upper surface of the upper case so as to be connected to each connection port.

A bush may be connected to the cooling block, avoiding the cooling passage, and the bush may be interposed between the upper case and the cooling block.

The battery system cooling apparatus configured in the structure described above may have battery modules and cooling blocks mounted in multiple stages, thereby diversifying the installation locations of the battery system, preventing leakage of a cooling medium, and reducing vibration of the battery to ensure stability.

### BRIEF DESCRIPTION OF THE DRAWINGS

The above and other aspects, features, and advantages of embodiments of the present disclosure will be more apparent from the following detailed description taken in conjunction with the accompanying drawings, in which:

FIG. 1 is a diagram illustrating an embodiment of a mobility to which a battery system of embodiments of the present disclosure is applied.

FIG. 2 is a diagram illustrating another embodiment of a mobility to which the battery system of embodiments of the present disclosure is applied.

FIG. 3 is a diagram illustrating a battery system according to embodiments of the present disclosure.

FIG. 4 is a cross-sectional view of the battery system cooling apparatus shown in FIG. 3.

FIG. 5 is an internal diagram of the battery system cooling apparatus shown in FIG. 3.

FIG. 6 is a diagram illustrating a cooling hose of the battery system cooling apparatus shown in FIG. 3.

FIG. 7 is a diagram illustrating a cooling block and a connection port of the battery system cooling apparatus shown in FIG. 3.

FIG. 8 is a diagram illustrating the connection of a cooling block and a cooling hose of the battery system cooling apparatus shown in FIG. 3.

FIG. 9 is a diagram illustrating the connection between a connector and a connection port of the battery system cooling apparatus shown in FIG. 3.

FIG. 10 is a diagram illustrating a bush of the battery system cooling apparatus shown in FIG. 3.

### DETAILED DESCRIPTION OF ILLUSTRATIVE EMBODIMENTS

Hereinafter, embodiments disclosed in the present specification will be described in detail with reference to the accompanying drawings, and the same or similar elements are given the same and similar reference numerals, so duplicate descriptions thereof will be omitted.

The terms “module” and “unit” used for the elements in the following description are given or interchangeably used in consideration of only the ease of writing the specification and do not have distinct meanings or roles by themselves.

In describing the embodiments disclosed in the present specification, when the detailed description of the relevant known technology is determined to unnecessarily obscure the gist of the embodiments of the present disclosure, the detailed description may be omitted. Furthermore, the accompanying drawings are provided only for easy understanding of the embodiments disclosed in the present specification, and the technical spirit disclosed herein is not limited to the accompanying drawings, and it should be understood that all changes, equivalents, or substitutes thereof are included in the spirit and scope of the present disclosure.

Terms including an ordinal number such as “first”, “second”, or the like may be used to describe various elements, but the elements are not limited to the terms. The above terms are used only for the purpose of distinguishing one element from another element.

In the case where an element is referred to as being “connected” or “coupled” to any other element, it should be understood that another element may be provided therebetween, as well as that the element may be directly connected or coupled to the other element. In contrast, in the case where an element is “directly connected” or “directly coupled” to any other element, it should be understood that no other element is present therebetween.

A singular expression may include a plural expression unless they are definitely different in a context.

As used herein, the expression “include” or “have” is intended to specify the existence of mentioned features, numbers, steps, operations, elements, components, or combinations thereof, and should be construed as not precluding the possible existence or addition of one or more other features, numbers, steps, operations, elements, components, or combinations thereof.

The embodiments of the present disclosure may be variously modified and include various exemplary embodiments in which specific exemplary embodiments will be described in detail hereinbelow. However, it shall be understood that the specific exemplary embodiments are not intended to limit the present disclosure thereto and cover all the modifications, equivalents, and substitutions which belong to the idea and technical scope of the present disclosure.

Hereinafter, a battery system cooling apparatus according to preferred embodiments of the present disclosure will be described with reference to the attached drawings.

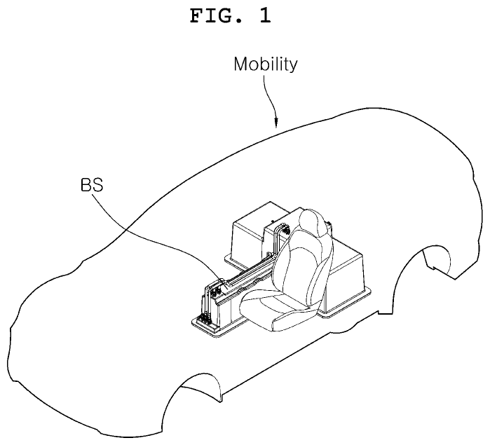

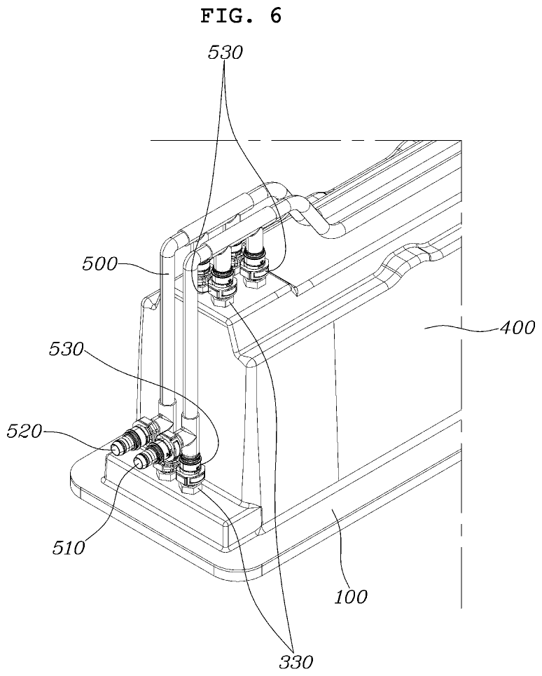

As shown in FIGS. 1 to 6, a battery system cooling apparatus according to embodiments of the present disclosure includes a lower case 100, a plurality of battery modules 200 mounted in multiple stages on the outer surface of the lower case 100, a plurality of cooling blocks 300 respectively attached to the outer surfaces of the battery modules 200 and forming a cooling passage 310, an upper case 400 coupled to the lower case 100 and formed to cover the battery modules 200 and the cooling blocks 300, and cooling hoses 500 including an inlet 510 and an outlet 520 for circulation of a cooling medium and connected in parallel to the cooling blocks 300, respectively, on the outside of the upper case 400.

The lower case 100 is provided with components including the battery modules 200 and the cooling blocks 300, and the upper case 400 is coupled thereto to seal the interior thereof.

The lower case 100 and the upper case 400 may be made of aluminum or steel, and they are coupled to each other to seal the interior thereof, thereby protecting components including the battery modules 200 and the cooling blocks 300.

The cooling block 300 may be attached to the lower case 100, and the battery module 200 may be attached to the cooling block 300 so that the temperature of the battery module 200 may be adjusted through heat exchange.

A cooling passage 310 may be formed in the cooling block 300 so that a cooling medium may be circulated, and the cooling medium may be cooling water.

In particular, embodiments of the present disclosure are configured such that the battery modules 200 and the cooling blocks 300 are mounted in multiple stages in the vertical direction. In other words, since a battery system BS is configured in multiple stages along the vertical direction, instead of being configured in a single stage, the battery system may be installed in various positions, not limited to the bottom of the mobility, in consideration of the indoor space of the occupants.

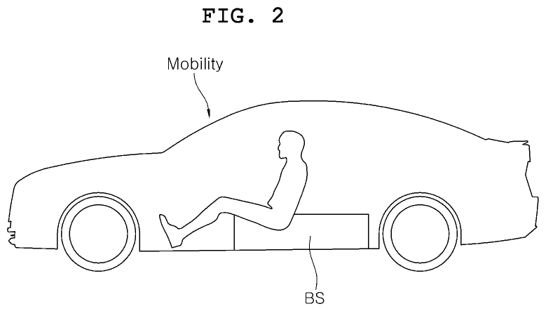

For example, as shown in FIG. 1, the battery system BS may be mounted on the front using the central tunnel portion in the center of the mobility, or as shown in FIG. 2, the battery system BS may be mounted on the rear using the space behind the driver's seat.

As described above, embodiments of the present disclosure are configured to include a plurality of battery modules 200 and cooling blocks 300 mounted in multiple stages in the vertical direction, thereby enabling the battery system BS to be configured as an atypical package.

The cooling hose 500 extends along the outside of the upper case 400 and is connected to each cooling block 300 so as to communicate therewith, and the cooling hose 500 includes an inlet 510 and an outlet 520 for circulation of the cooling medium.

In addition, the cooling hoses 500 may extend along the outside of the upper case 400 and may be connected in parallel to the cooling blocks 300, respectively, thereby uniformly and stably providing the cooling medium to the respective cooling blocks 300.

In particular, conventionally, since a nipple for connecting the cooling hose 500 and the cooling block 300 is located inside the case, the ease of fastening is reduced, which may lead to leakage of the cooling medium due to poor fastening. However, in embodiments of the present disclosure, since the cooling hose 500 is connected to each cooling block 300 from the outside of the upper case 400, work convenience may be improved and the outflow stability of the cooling medium is ensured.

The cooling hose 500 may be configured to circulate the cooling medium through an external electric water pump, reservoir, heater, chiller, or the like, so that the temperature of the cooling medium may be controlled.

Meanwhile, electrical equipment 600 may be provided on the upper side of the uppermost battery module 200 among the plurality of battery modules 200, and the cooling block 300 may be attached to the outer surface of the electrical equipment 600.

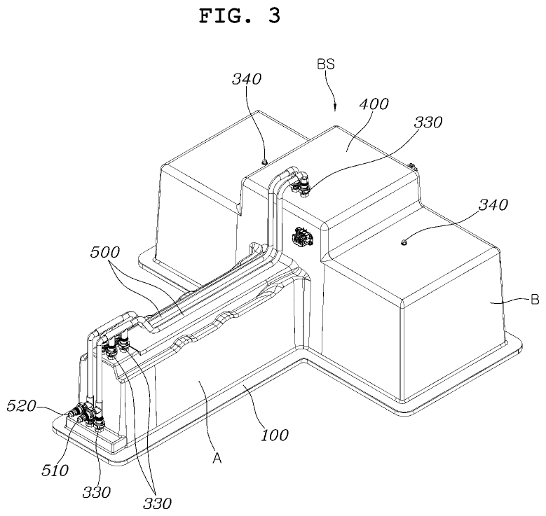

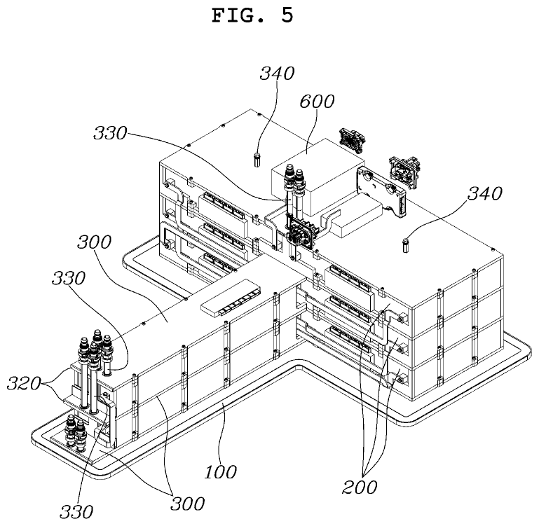

As shown in FIGS. 3 and 5, the battery modules 200 may be mounted in multiple stages in the vertical direction, and the electrical equipment 600 may be provided above the uppermost battery module 200, so that the electrical equipment 600 may be provided without interference with the arrangement of the respective battery modules 200 inside the upper case 400 and the lower case 100.

In addition, the cooling block 300 may be attached to the outer surface of the electrical equipment 600 to share the cooling medium circulated through the cooling hose 500, thereby controlling the temperature of the electrical equipment 600.

Here, the cooling hoses 500 may be connected such that the cooling medium initially flows through the cooling blocks 300 matched to the respective battery modules 200 and lastly flows to the cooling block 300 matched to the electrical equipment 600.

Since the electrical equipment 600 is not as sensitive to temperature management as the battery module 200, the cooling hoses 500 may be configured such that the cooling medium flows to the cooling block 300 matched to the electrical equipment 600 after flowing through the cooling blocks 300 matched to the respective battery modules 200, thereby managing the temperature of the electrical equipment 600 while stably maintaining the temperature of each battery module 200.

Although this electrical equipment 600 may be provided on the side of the battery module 200, the electrical equipment 600 may be disposed at the top to optimize the structure in which the battery modules 200 are mounted in multiple stages, and the cooling hoses 500 may be easily connected to the respective cooling blocks 300 matched to the battery modules 200 and the electrical equipment 600.

Meanwhile, the lower case 100 and the upper case 400 may be configured as a front part A and a rear part B, and the front part A and the rear part B may be connected at right angles to form a T shape.

Accordingly, the lower case 100 and the upper case 400 may secure space on both sides of the front part A, thereby securing interior space on both sides of the front part A for other components to be provided. In addition, since the rear part B is arranged to be perpendicular to the front part A, even if the size of the battery module 200 increases, it may be accommodated in the rear part B.

In particular, since the lower case 100 and the upper case 400 are configured to intersect at a right angle, the battery system BS may be disposed at the front using the central tunnel portion of the mobility.

Each cooling block 300 may have both ends sealed by sealing portions 320, and a cooling passage 310 may be formed inside the same.

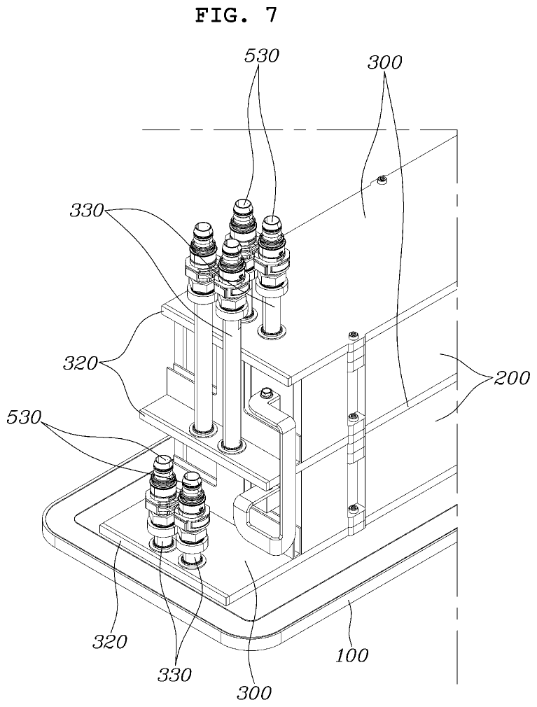

As shown in FIG. 7, the cooling block 300 may be mounted in the vertical direction and may be formed to have different lengths in the longitudinal direction. This cooling block 300 has a cooling passage 310 formed inside the same, and sealing portions 320 are joined to both ends through welding to seal the inside of the cooling block 300.

Accordingly, when manufacturing the cooling blocks 300, the respective cooling blocks 300 are molded to have different lengths, and sealing portions 320 are joined to both ends to prevent leakage of the cooling medium, thereby securing the ease of manufacturing the cooling block 300.

Meanwhile, each cooling block 300 may have a connection port 330 to which the cooling hose 500 is connected, and the connection port 330 may extend upwards from the cooling block 300 and may be connected to the cooling hose 500 by passing through the upper case 400.

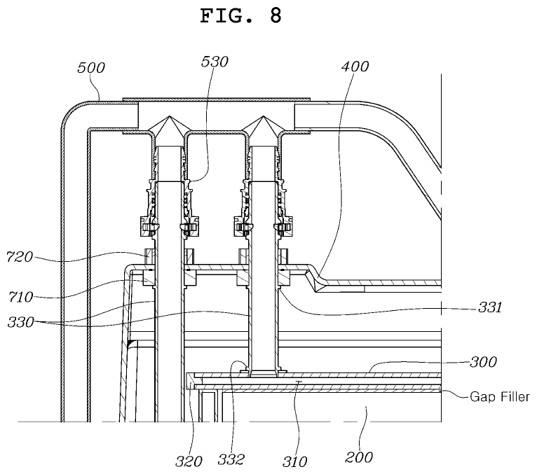

As shown in FIGS. 7 and 8, the connection port 330 extends from the upper surface of the cooling block 300 to pass through the upper case 400 so that the cooling hose 500 is connected to the connection port 330. This connection port 330 is provided in each cooling block 300 and connected to the cooling hose 500 to enable the cooling medium to circulate inside each cooling block 300.

Additionally, although the connection port 330 may be manufactured integrally with the cooling block 300, for convenience of manufacturing, it may be manufactured separately and then welded to the cooling block 300. Accordingly, a support protrusion 332 may be formed at the lower end of the connection port 330, so that the support protrusion 332 of the connection port 330 may be welded and joined while seated on the upper surface of the cooling block 300.

In particular, the lowermost cooling block 300 of the plurality of cooling blocks 300 according to embodiments of the present disclosure may be formed to have the largest length in the longitudinal direction, and the cooling block 300 may have a smaller length in the longitudinal direction as it is closer to the top.

In particular, as first ends of the plurality of cooling blocks 300 are positioned to match each other in the vertical direction, the other ends thereof may be arranged in the form of stairs, and the connection ports 330 may be provided at the ends arranged in the stair form.

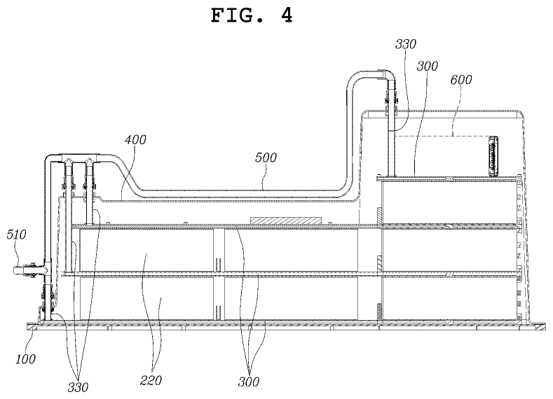

As shown in FIGS. 4 and 7, the battery modules 200 and the cooling blocks 300 are mounted in multiple stages inside the lower case 100 and the upper case 400, and the cooling blocks 300 are formed to have a smaller length in the longitudinal direction as they are closer to the top so that the respective cooling blocks 300 are arranged in the form of stairs.

As described above, since the plurality of cooling blocks 300 are formed with different lengths and arranged in the form of stairs through the length differences, even if the connection port 330 extends upwards from the upper surface of each cooling block 300, interference with other cooling blocks 300 may be avoided.

In other words, the connection ports 330 may be provided in portions of the respective cooling blocks 300 corresponding to differences in length, thereby avoiding interference between the cooling blocks 300 in the vertical direction, and the connection ports 330 may vertically extend upwards through spaces in which the cooling blocks 300 do not interfere with each other and pass through the upper case 400.

In addition, the connection ports 330 extending from the respective cooling blocks 300 are positioned to be spaced apart from each other in the upper case 400, so that the cooling hose 500 may be connected to the respective connection ports 330.

That is, since the connection ports 330 of the respective cooling blocks 300 are arranged to be spaced apart from each other in the longitudinal direction of the cooling block 300 without overlapping each other in the vertical direction, the cooling hose 500 extending only in the longitudinal direction of the cooling block 300 on the outside of the upper case 400 may be connected to the respective connection ports 330. Accordingly, the cooling hose 500 may be simplified, instead of being complicated.

As described above, since the respective cooling blocks 300 have a stepwise arrangement structure, the alignment of the respective connection ports 330 and the connection of the cooling hose 500 may be simplified.

Meanwhile, the lower end of the connection port 330 may be connected to the cooling passage 310 of the cooling block 300 so as to communicate therewith, a locking protrusion 331 may be formed at the upper end thereof, and a first fastening member 710 may be seated on the locking protrusion 331 so as to be interposed between the outer surface of the upper case 400 and the locking protrusion 331.

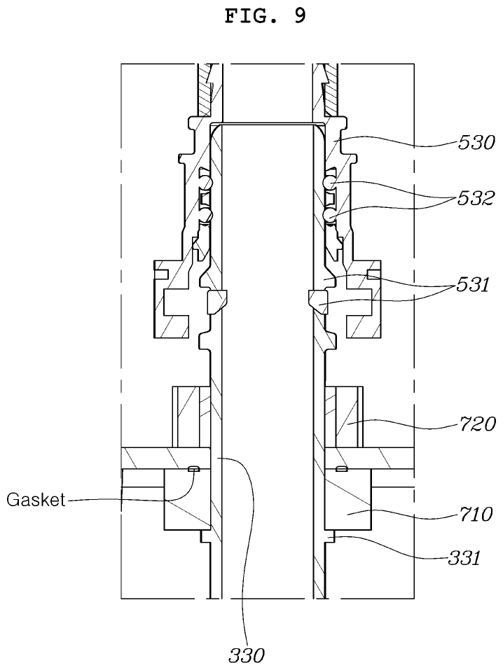

As shown in FIGS. 8 and 9, the lower end of the connection port 330 is coupled to the upper surface of the cooling block 300 to communicate with the cooling passage 310.

In addition, the locking protrusion 331 is formed at the upper end of the connection port 330, and the first fastening member 710 is seated on the locking protrusion 331 so that the connection port 330 and the upper case 400 are coupled to each other. In addition, since the locking protrusion 331 is formed in the connection port 330, the first fastening member 710 may be primarily fixed in its position and then completely fixed by fastening of the first fastening member 710.

Here, the first fastening member 710 may be configured as a nut including a gasket, and the portion of the upper case 400 through which the connection port 330 passes is sealed through the gasket in contact with the upper case 400 on the inside thereof.

In addition, a second fastening member 720 may be further provided in a portion on the upper surface of the upper case 400 through which the connection port 330 passes so as to be connected to the connection port 330.

The second fastening member 720 may be configured as a nut including a gasket and may seal the portion of the upper case 400 through which the connection port 330 passes by a gasket in contact with the upper case 400 on the inside thereof.

As described above, the upper case 400 may have the first fastening member 710 coupled to the lower side of the part through which the connection port 330 extending from each cooling block 300 passes and the second fastening member 720 coupled to the upper side thereof to seal the portion through which the connection port 330 passes, maintaining airtightness.

In addition, since the connection port 330 is connected to the upper case 400 through the first fastening member 710 and the second fastening member 720, the position of the connection port 330 may be constrained in the upper case 400, and the weak portion of the upper case 400 caused by penetration of the connection port 330 may be reinforced in its rigidity by the first fastening member 710 and the second fastening member 720, thereby reducing vibration.

Meanwhile, the cooling hose 500 may be connected to the connection port 330 via the connector 530, he connector 530 and the connection port 330 may have a fastening protrusion or groove 531 formed therein to provide a mutual locking structure, and the sealing body 532 may be interposed between the connector 530 and the connection port 330.

As shown in FIG. 9, the connector 530 is intended to connect the cooling hose 500 and the connection port 330 and may be configured as a T pipe.

Here, the cooling hose 500 is coupled to the connector 530, and the connection port 330 is fastened to the connector 530, so that the cooling hose 500 and the connection port 330 communicate with each other through the connector 530, enabling the cooling medium to circulate.

Here, the connector 530 and the connection port 330 are formed with the protrusions or grooves 531 for fastening, so that the protrusions and grooves are inserted into each other to form a locking structure.

In addition, when the connection port 330 is inserted into the connector 530 and connected to each other in a locking structure, a sealing body 532 may be interposed between the connector 530 and the connection port 330 to seal the gap between the connector 530 and the connection port 330.

The sealing body 532 may be configured as a rubber ring, and a plurality of sealing bodies 532 may be configured and arranged in the connection direction of the connector 530 and the connection port 330.

Meanwhile, the cooling hose 500 may extend along the upper surface of the upper case 400 so as to be connected to each connection port 330.

As shown in FIGS. 3 and 4, the cooling hose 500 may extend along the shape of the upper surface of the upper case 400, thereby minimizing interference with other components even if the cooling hose 500 is provided outside the upper case 400.

In addition, in embodiments of the present disclosure, since the connection port 330 of each cooling block 300 extends upwards and is exposed to the upper side of the upper case 400, the cooling hose 500 may be connected to each connection port 330 on the upper surface of the upper case 400.

Meanwhile, a bush 340 may be connected to the cooling block 300, avoiding the cooling passage 310, and the bush 340 may be interposed between the upper case 400 and the cooling block 300.

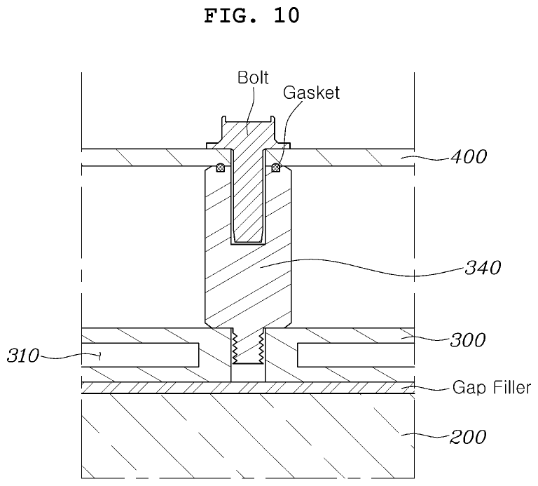

As shown in FIG. 10, the upper case 400 and the cooling block 300 may be connected to each other via the bush 340, thereby reducing the vibration of the upper case 400.

The bush 340 may be connected to a portion of the cooling block 300 in which the cooling passage 310 is not formed and may be interposed between the cooling block 300 and the upper case 400, thereby supporting the upper case 400 and reducing vibration.

This bush 340 may be bolted and fixed to the upper case 400 and may be configured to ensure airtightness by further including a gasket in contact with the upper case 400.

As described above, the bush 340 may be provided in a portion of the upper case 400 where vibration reduction is required and may constrain the upper case 400 while being connected to the cooling block 300, thereby supporting the upper case 400 and reducing vibration.

The battery system cooling apparatus configured in the structure described above may have battery modules 200 and cooling blocks 300 mounted in multiple stages, thereby diversifying the installation locations of the battery system and securing outflow stability of a cooling medium.

Although embodiments of the present disclosure have been described and illustrated in conjunction with particular embodiments thereof, it will be apparent to those skilled in the art that various improvements and modifications may be made to the embodiments of the present disclosure without departing from the technical idea of the embodiments of the present disclosure defined by the appended claims.

What is claimed is:

1. A battery system cooling apparatus, the apparatus comprising:
a lower case;
a plurality of battery modules mounted in multiple stages on an outer surface of the lower case;
a plurality of cooling blocks respectively attached to outer surfaces of the battery modules and defining a cooling passage;
an upper case coupled to the lower case and covering the battery modules and the cooling blocks; and
a cooling hose respectively connected in parallel to the cooling blocks on an outside of the upper case, the cooling hose comprising an inlet and an outlet for circulation of a cooling medium.

2. The apparatus of claim 1, further comprising electrical equipment disposed on an upper side of an uppermost battery module among the plurality of battery modules, wherein a cooling block of the plurality of cooling blocks is attached to an outer surface of the electrical equipment.

3. The apparatus of claim 2, wherein the cooling hose is connected such that the cooling medium initially flows through the cooling blocks matched to the respective battery modules and lastly flows to the cooling block matched to the electrical equipment.

4. The apparatus of claim 1, wherein the lower case and the upper case are configured as a front part and a rear part so that the front part and the rear part are connected at right angles to have a T shape.

5. The apparatus of claim 1, wherein each cooling block has both ends sealed by sealing portions so that the cooling passage is defined inside the cooling block.

6. The apparatus of claim 1, further comprising a bush connected to a cooling block of the plurality of cooling blocks, avoiding the cooling passage, wherein the bush is interposed between the upper case and the cooling block.

7. A battery system cooling apparatus, the apparatus comprising:
a lower case;
a plurality of battery modules mounted in multiple stages on an outer surface of the lower case;
a plurality of cooling blocks respectively attached to outer surfaces of the battery modules and defining a cooling passage, each of the cooling blocks having a connection port;
an upper case coupled to the lower case and covering the battery modules and the cooling blocks; and
a cooling hose respectively connected in parallel to the connection ports of the cooling blocks on an outside of the upper case, the cooling hose comprising an inlet and an outlet for circulation of a cooling medium, wherein the connection ports extend upwards from the cooling blocks to be connected to the cooling hose by passing through the upper case.

8. The apparatus of claim 7, wherein a lowermost cooling block of the plurality of cooling blocks has a longest length in a longitudinal direction, and wherein each of the cooling blocks has a progressively smaller length in the longitudinal direction as it gets closer to an uppermost cooling block of the plurality of cooling blocks.

9. The apparatus of claim 8, wherein first ends of the plurality of cooling blocks are positioned to match each other in a vertical direction and second ends of the plurality of cooling blocks are arranged in a stair step pattern, and wherein the connection ports are disposed at the second ends arranged in the stair step pattern.

10. The apparatus of claim 7, wherein:
a lower end of the connection port is connected to the cooling passage of the respective cooling block so as to communicate therewith;
a locking protrusion is disposed at an upper end of the connection port; and
a first fastening member is seated on the locking protrusion so as to be interposed between the outer surface of the upper case and the locking protrusion.

11. The apparatus of claim 10, further comprising a second fastening member disposed in a portion on an upper surface of the upper case through which the connection port passes so as to be connected to the connection port.

12. The apparatus of claim 7, wherein:
the cooling hose is connected to the connection port via a connector;
the connector and the connection port have a fastening protrusion or groove disposed therein to define a mutual locking structure; and
a sealing body is interposed between the connector and the connection port.

13. The apparatus of claim 7, wherein the cooling hose extends along an upper surface of the upper case so as to be connected to each of the connection ports.

14. The apparatus of claim 7, further comprising a bush connected to a cooling block of the plurality of cooling blocks, avoiding the cooling passage, wherein the bush is interposed between the upper case and the cooling block.

15. The apparatus of claim 7, further comprising electrical equipment disposed on an upper side of an uppermost battery module among the plurality of battery modules, wherein a cooling block of the plurality of cooling blocks is attached to an outer surface of the electrical equipment.

16. The apparatus of claim 15, wherein the cooling hose is connected such that the cooling medium initially flows through the cooling blocks matched to the respective battery modules and lastly flows to the cooling block matched to the electrical equipment.

17. The apparatus of claim 16, wherein the lower case and the upper case are configured as a front part and a rear part so that the front part and the rear part are connected at right angles to have a T shape.

18. The apparatus of claim 7, wherein the lower case and the upper case are configured as a front part and a rear part so that the front part and the rear part are connected at right angles to have a T shape.

19. The apparatus of claim 7, wherein each cooling block has both ends sealed by sealing portions so that the cooling passage is defined inside the cooling block.

20. The apparatus of claim 19, further comprising a bush connected to a cooling block of the plurality of cooling blocks, avoiding the cooling passage, wherein the bush is interposed between the upper case and the cooling block.
